(19) United States
(12) Patent Application Publication
(10) Pub. No.: US 2007/0288271 A1
(43) Pub. Date: Dec. 13, 2007

(54) Sub-prime automobile sale and finance system

(76) Inventor: Kirk William Klinkhammer, Las Vegas, NV (US)

Correspondence Address: Kirk W. Klinkhammer, 7561 Cultural Court, Las Vegas, NV, 89149, US

(21) Appl. No.: 11/809,695

(22) Filed: Jun. 1, 2007

Related U.S. Application Data
(60) Provisional application No. 60/812,926, filed on Jun. 13, 2006.

(51) Int. Cl. G06Q 40/00; G01C 21/00

(52) U.S. Cl. 705/4; 701/213; 705/38

(57) ABSTRACT

A system to provide automobile financing to individuals with relatively lower credit scores or ratings, or no credit rating, due to lack of credit or lending purchases, that would otherwise only qualify for sub-prime, higher interest loans. Due to the overall system structure, lower rate interest loans can be extended to participants. The system utilizes the auto financing loan applicant's term of employment and/or other employment performance data as the principal credit criteria to qualify the creditworthiness of an applicant versus the applicant's credit score or credit rating. Applicant's driving records are also reviewed as system automobile loan approval credit criteria. Loan applicants provide employment related information and execute a letter of authorization providing the system with authority/rights to contact the applicant's employer to verify said employment information. In order to provide participants with lower interest rates than would otherwise be available through conventional channels, automobiles financed under the system must meet minimum profile criteria, including the year of the auto, the mileage, retail value relative to the wholesale value, and autos financed under the system are covered by extended warranties and have GPS systems installed for asset protection purposes. In utilizing employment term as the principal creditworthiness criteria, the system can to be offered through employers as an employee loyalty reward program.

### BACKGROUND OF THE INVENTION

The interest rate cost of financing automobiles for individuals with late payments or a history of late payments on their credit score ratings, or who have had a bankruptcy, an automobile repossession for non-payment or who, for lack of establishing a credit history rating, have no credit rating from historical performance, is very expensive.

Generally, a credit score or rating is a value assigned to an individual based on their credit related payment history, which credit scores/rating are used by banks or other sources in to determine whether to extend credit or make other lending or credit related decisions. This credit related payment history, or credit criteria, typically includes the amount you owe on credit accounts such as credit cards, automobile loans, etc., and your payment history with the same, i.e., whether a person has a history of prompt, timely or late payments. Scorers take information from an aggregate of an individual's credit accounts and plug it into formulas that calculate a value representing the amount of risk an individual may pose to a lender. That value takes into account the track record of other consumers with similar credit profiles. By looking at this value, or score, lenders gauge whether it's a good idea to extend an individual credit and the relative amount of the risk of such an extension of credit. For example, Fair Isaac Corporation (NYSE: FIC) calculates the widely used FICO credit score on a scale ranging from 300 to 850, where the higher the score the better the credit rating. FICO scores are used worldwide by lenders to judge an individual's credit worthiness. The score calculated generally utilizes credit related information from three of the main credit bureaus: TransUnion, Experian and Equifax. Discrepancies between information from each of the individual credit bureaus can affect the score, and by extension the interest rate on a loan a customer receives.

In addition to an individual's credit score, lenders will also take into account such factors as current income and earning potential, both indicators of an ability to repay a loan. For this reason two borrowers with above-average FICO scores of 660 can get different interest rates.

The term used in the auto finance industry for the financing provided to automobile buyers with relatively lower credit scores or ratings is “sub-prime” financing. Interest rates for sub-prime automobile financing can range from 18% APR to 28% APR, and the cost of such higher interest rates is substantial. For example; the added interest expense required to finance a $16,000 automobile over a 60-month term at 22% APR versus 9% is $6,500.

There are many reasons individuals end up being late in making payments to credit accounts, which, in turn, result lower credit scores/ratings. Many of these reasons are the result of “out of the ordinary” events or circumstances that come and go, or pass. These reasons are more a result of the circumstances rather than the character, motivation or commitment of the individual being affected, i.e., sudden and unexpected family obligation related expenses, loss of a job for reasons out of the individuals control, etc. In such instances, the individual realizing the reduction in their credit score will be required to pay a significantly higher price to access and use credit. Furthermore, owing reliable transportation is an important factor for most adults to manage their everyday lives and as a result purchasing an automobile at regular intervals is a common and practical requirement for most families. Therefore, credit score compromised individuals often have to pay the higher “penalty” price when they purchase an automobile, even if their poor credit rating is only a reflection of an isolated event, rather than their true credit worthiness based on their, character, commitment and ability.

While lenders take other factors into consideration besides credit scores, i.e., existing debt, and debt to income ratios, credit scores remain the primary factor lenders consider in determining the interest rate borrower pays. While credit scores certainly provide valuable information to consider in determining an individual's credit worthiness, there are other factors that provide valuable and useful information in determining a individual's credit worthiness.

One such category of information is the employment history of an individual. Specifically, the term a person has remained in good standing as an employee. For example: An employee who has managed to maintain his/her employment with a single employer for a defined minimum term, say 2 or 3 years. This employee performance information demonstrates an individual's commitment and responsibility while simultaneously being the strongest indicator of current and future employment or income generating capacity. Another such category is driving records. In order to protect the asset during the term of an auto loan, financial institutions generally require borrowers to maintain full coverage auto insurance. And a bad driving record will substantially increase the amount an individual will have to pay for insurance. Therefore, an individual's driving record, which indicates the amount they will be required to pay for insurance, provides valuable information to evaluate an individual's ability to manage an auto loan payment obligation. Furthermore, a driving record, like employment term, and like, but as an alternative to “credit history”, provides evidence of how an individual manages personal responsibility, and shows consideration for rules and regulations.

What is needed is a system that allows individuals who have lower credit scores or ratings that result primarily from the occurrence of out of the ordinary circumstances, to secure automobile financing at lower rates. Such a system would utilize credit criteria that strongly demonstrates the character, commitment and responsibility of an individual, but that is used as an alternative and in lieu of credit payment history data. Such alternative credit criteria could focus on employment history and driving records as the principal data evaluated. These new criteria provide real, demonstrable evidence from everyday life as to an individual's responsibility level, commitment, dependability, and character.

### SUMMARY OF THE INVENTION

The system provides an automobile financing alternative to individuals with relatively low or no credit scores or ratings, who would otherwise only qualify for higher interest rate, sub-prime auto loans; allowing them to purchase automobiles at interest rates that are at a significant discount to sub-prime rates.

Rather than looking to commonly used “credit scores” or “credit ratings” the system utilizes term of employment, and/or other employment performance data, and driving record as the principal criteria in determining an applicant's credit worthiness. Employment history indicates an individual's commitment and responsibility level, as well as providing the best indication of current and future income. Similarly, a driving record also indicates an individual's responsibility and consciousness as well the cost an individual will pay for auto insurance, typically a significant monthly budget expense.

Typically, the higher interest rates paid by individuals who only qualify for sub-prime automobile financing allow lenders to manage the cost of the risk associated with the categorical grouping of these “higher risk” borrowers. A large percentage of individuals who are required to pay sub-prime lending rates are bad risks and deserve to pay higher rates due to relevant patterns of behavior, lower regard for responsibility, etc. On the other hand, a good percentage of the individuals in this categorical grouping are there because of unusual circumstances that resulted in a disruption to their credit score or rating. The present invention seeks to provide a system to (i) identify, through alternative credit criteria, such sub-prime individuals who are responsible and should deserve to pay lower interest rates, (ii) allow such individuals the opportunity to by-pass said credit score lowering aberration(s), and (iii) provide a means to re-demonstrate themselves, with the condition of certain performance criteria and penalties for non-performance, without the necessity of having to pay the higher “sub prime” interest rate in the process.

Upon identifying individuals under the system's new credit criteria, the key components of the system that make it possible to provide such individuals with substantially lower interest rates than they would otherwise be required to pay (for sub-prime automobile financing) include: (i) limiting the autos financed under the system to those that meet certain useful life, reliability criteria and that generate certain minimum gross margins on a sale, and (ii) maintaining and enforcing certain system asset protection and recovery rules/regulations. First, the system limits the selection of the automobiles available to be purchased under the system to those with profiles that generally allow said autos to be dependable during the term of the loan. Specifically, that autos financed only have a minimum number of miles on the automobile and not be more than a certain number of years old at the time they are initially financed. The system also limits the selection of the automobiles to those with that have certain minimum margins between the wholesale price and the retail price. These parameters allow the system to capture certain minimum automobile dealership profit margins on autos sold, and to ensure that such autos maintain a certain minimum value during the corresponding auto financing term. Then, if it's necessary to repossess an auto financed under the system, the auto can be effectively re-sold at a reasonable value.

It is a feature of the system that it operate as an automobile dealership business within the system to capture and utilize margin from the said dealership to offset the potential risk of the lower interest loans provided to the sub-prime borrowers (under the system). This allows the system to align the interests between the “financing” and “dealership” services and create a common interest in managing the total profit potential of the automobile sale and financing transaction. Furthermore, the system design allows financial institutions to contribute or forego margins from higher interest auto loans in exchange for utilizing the system as a marketing vehicle to capture and profit from building its financial institution customer base, and, thereafter, profiting from related non-auto financing business. For example, community credit unions, which do not have the ability to compete with the marketing budgets of commercial banks, can contribute the lower interest auto loans (to system participants) to build their overall membership base and business. In turn, the system can utilize its dealership profit margins, and the competitive advantages of the system design, to, in affect, guarantee the performance of the lower interest auto loans made by such financial institutions.

In a preferred embodiment of the system, the system works with an employer and the employer allows the system to distribute information on the system's lower interest rate auto financing program to its employees. The system distributed information informs employees that a minimum of two years of employment (or such other minimum employment term qualification) is required to qualify for the lower interest rate auto financing program. Interested employees who receive information on the auto finance program contact the system via phone, email, etc. Upon such contact, employees are provided with and execute a letter of authorization, authorizing the system to verify the term of said employees employment term with employer. Upon receiving the authorization letter from the employee, the system in turn contacts the employer and verifies the term of the employee's employment with employer.

System applicants verified as meeting the minimum employment term are invited to attend a prequalification interview with a system representative, where they complete an insurance application form. The system representative uses the application to access the applicant's driving record. Upon verifying that applicant has a satisfactory driving record, applicant is “pre-approved” for the program. Upon being pre-approved, applicant is scheduled to attend a program budgeting/application processing meeting.

At the budgeting/application processing seminar the applicant is taken through all the component features of the program and the applicant and representative work through relevant personal budgeting factors to ensure applicant has an overall understanding of the program and their ability to personally manage the related auto financing. Other component features of the budgeting/application processing seminar include, reviewing types of autos available under the system program; financing interest rates; requirement for applicant to maintain full coverage insurance during term of loan; the system's maintenance of a warranty on the subject auto during term of loan; requirement that applicant establish a new bank account wherefrom automatic withdrawals will be made to make monthly auto payments for financing due under the system; system's automatic payroll deposit of employees payroll checks to said account; and the conditions of repossession of autos financed under the system in the event of non-payment by applicant under the system.

Upon successfully completing budgeting/application processing seminar, applicant sets up a new bank account for program payment process and employer direct deposit forms. Upon verifying a direct deposit from employer to applicant account, applicant enters can enter process of selecting and purchasing and automobile. Upon applicant's selection of an auto, system purchases auto and concludes auto financing. GPS units are installed in autos sold under the system to facilitate repossession of autos and recovery of auto asset in the event of non payment performance by applicant.

### BRIEF DESCRIPTION OF THE DRAWINGS

FIG. 1 is a diagram of the principal features and components of the automobile sale and finance system;

FIG. 2 is a diagram illustrating one potential preferred embodiment of the present automobile sale and finance system;

FIG. 3 is a diagram illustrating one potential preferred embodiment of the present automobile sale and finance system;

### DESCRIPTION OF THE PREFERRED EMBODIMENT

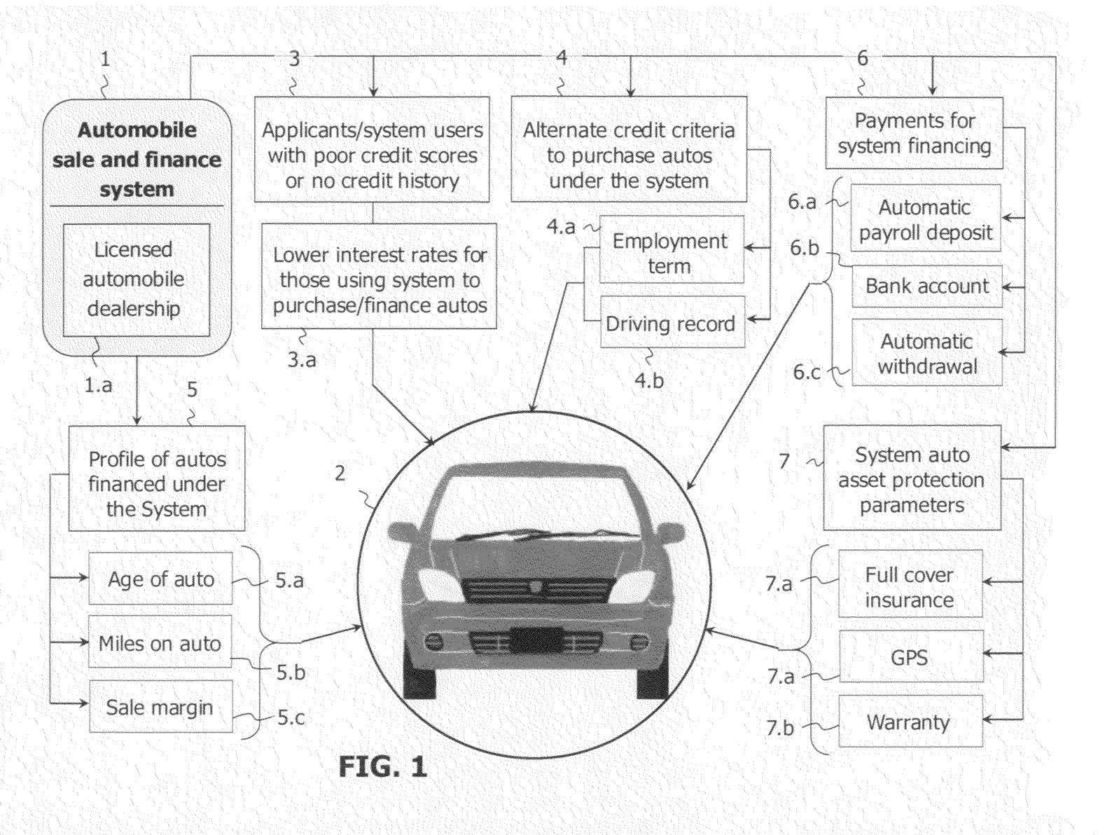

There is shown in FIG. 1 an automobile sale and finance system 1 to sell and finance automobiles 2. The system 1 is compromised of the primary function and features defined in 3 and the operating components defined in 4 through 7.

The primary objective of the system 1 is to provide the function 3 of providing individuals with poor or no credit scores or history, that would otherwise be required to pay sub prime auto financing interest rates (i.e., high interest rates), with an alternative to receive significantly lower interest rates for auto financing 3.a. Under the system 1 individuals with poor or no credit history 3 are not evaluated based on typical credit history scores or ratings, such as FICA credit scores, which scores are generally calculated utilizing credit related information from the main credit bureaus, i.e., TransUnion, Experian and Equifax. Alternatively, the system 1 collects alternative credit criteria 4 to evaluate the auto financing credit worthiness of individuals with poor or no credit history 3. Specifically, the system 1 utilizes an applicant's 3 (i) term of employment 4.a., and (ii) driving record 4.b.

In order to providing operating margins to offset the risk of providing system users 3 with the lower interest rates 3.a. the system 1 operates as an automobile dealership 1.a. to capture dealership related profits. To control the level of dealership 1.a. related profit margins to offset the risk of lower interest rates 3.a, the dealership 1.a. limits the type of automobiles 2 that are made available to applicants 3 the under the system 5. The type of automobiles 2 are limited by the age of the auto, the miles on the auto at the time financed, and the sale margin of the auto. Specifically, automobiles 2 financed under the system 1 are (i) not more than 1-3 years old at the time of sale 5.a; (ii) do not have more than 50,000 miles on the automobile 2 odometer at the time of sale 5.b.; and (iii) the value of the quotient of the Kelly Blue book retail value minus the corresponding retail value divided by said retail value is equal to Twenty Five Percent (25%) or greater 5.c. These limitations help to ensure that the automobiles 2 sold by the dealership 1.a. and financed under the system 1 will have greater dependability and reliability during the term of the system 1 financing and will generate adequate profit margins to manage potential risk to offset the lower interest rate 3.a. provided to system users 3 under the system 1. Similarly, in the event of a default by a system user 3 in making an automobile 2 payment when due and a subsequent repossession of an automobile 2, the type of automobiles 2 available the under the system 5 also increases the system's ability to recapture value when subsequent re-marketing and sale is required in such a repossession.

To assist the system 1 in monitoring the collections of payments for system financing 6 due under system 1 auto financing for automobiles 2, the system requires system users 3 to set up an automatic payroll deposit with their employer 6.a, and point such payroll deposit 6.a. to an established or new bank account 6.b. The applicant/system user 3 then provides written authorization for the automobile 2 financing due under the system 1 to be automatically withdrawn from the applicant/system user 3 when such payments are due 6.c under the system 1.

To protect the automobile 2 assets financed under the system 1, the system 1 has automobile 2 asset protection parameters 7. These parameters 7 include (i) requiring the system users 3 to maintain full coverage automobile insurance on automobiles 2 financed under the system 7.a.; (ii) the installation of global positioning systems (GPS) on automobiles 2 financed under the system 7.b; and (iii) the system's 1 maintenance of bumper-to-bumper warranties on automobiles 2 financed under the system 7.c during the term of the system 1 financing.

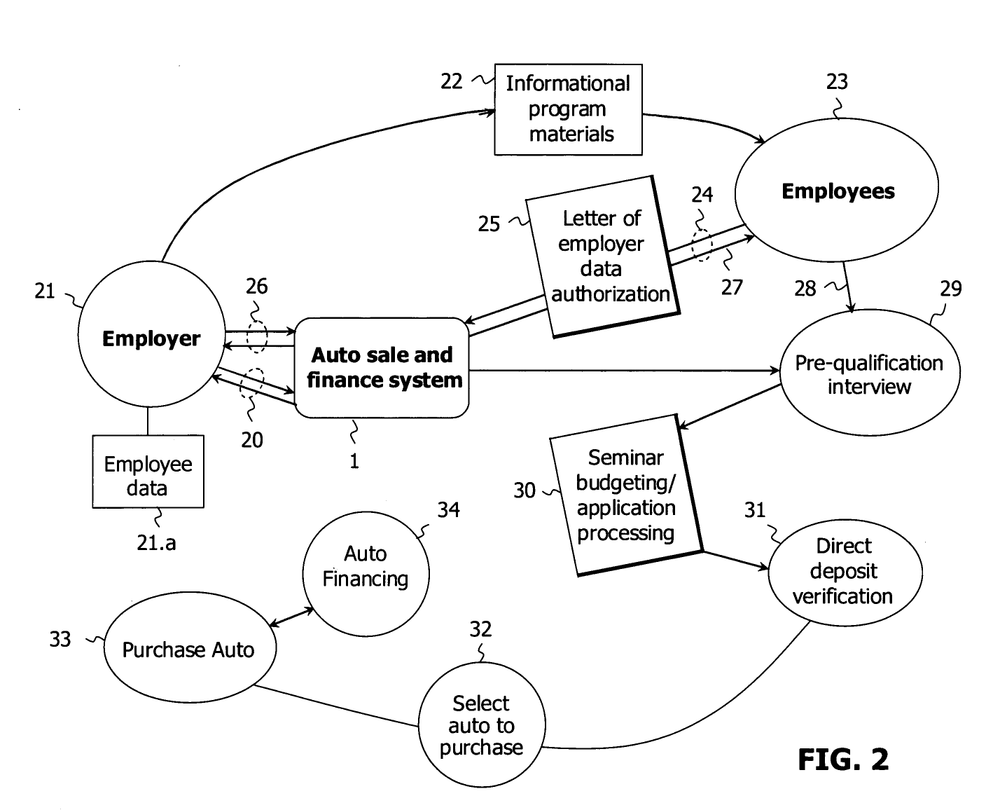

There is shown in FIG. 2 a preferred embodiment of the automobile sale and finance system 1 to sell and finance automobiles 2. In this embodiment the system 1 approaches an employer 21, presents and explains the system 1 program, and enters into agreement with the employer 21 to participate in and promote the program 20. The employer 21 then provides informational materials defining the system 1 program 22 to its employees 23. Interested employees 23, presumably ones who meet the minimum employment term criteria defined in the system 1 program informational materials 22 (e.g., a minimum of two years of employment), then contact the system 24 and are provided with a letter of authorization 25 to execute and return to the system 24. Upon receipt of the letter of authorization 25 executed by the employee 23, the system 1 provides the executed letter of authorization to the employer 26 requesting verification of the employee's 23 term of employment with the employer 21. Upon accessing the employee data files 21.a. the employer 21 verifies the employment term of the employee 26 to the system 1. Upon receipt of the employment term verification 26, the system 1 instructs employee 27 that they are authorized to contact a system representative 28 to set up a prequalification interview 29.

At the prequalification interview 29, the employee 23, who is now a first stage system applicant 3, the applicant 3 is provided with a full disclosure of information regarding operations of the system 1, the applicant 3 performance and commitment requirements and the consequences of non-performance. In a performed embodiment of the present invention the system 1 is a licensed insurance agent, and as such, has the ability to access the applicant's 3 driving record 4.b information. To access the driving record 4.b information the prequalification interview system 1 representative has the applicant 3 complete an insurance application form and therefrom accesses applicant's 3 driving record information. The system 1 has minimum criteria drivers license record 4.b performance qualifications.

The prequalification interview system 1 representative then discloses the system's 1 material performance and commitment requirements and the consequences of non-performance, including informing applicant verbally and in writing that (i) system users 3 will a lower interest rate that that otherwise available for auto loans to individuals with sub prime credit; (ii) collections of payments for system financing 6 require system users 3 to set up an automatic payroll deposit with their employer 6.a, point such payroll deposit 6.a. to an established or new bank account 6.b, and that automobile 2 financing payments due under the system 1 will be automatically withdrawn from said system user's 3 bank account when such payments are due 6.c, (iii) system users 3 will have their automobile 2 repossessed more quickly than through conventional bank financing channels in the event of a default in a monthly payment due under the system; and (iv) that system users 3 will be required to maintain full coverage auto insurance during the term of the system 1 financing.

If the system 1 applicant meets the system's 1 minimum criteria for drivers license record 4.b, and acknowledges, in writing, that the prequalification interview system 1 representative has disclosed the system's 1 material performance and commitment requirements and the consequences of non-performance, defined above, are understood and agreed to, then, the prequalification interview system 1 representative will grant the system applicant 3 a “preliminary approval” for a system 1 auto financing commitment.

Upon a receiving preliminary approval for a system 1 auto financing commitment prequalification interview system 1 representative, the system applicant 3 is scheduled to attend a system 1 budgeting/application processing meeting 30. At the system 1 budgeting/application processing meeting 30 the applicant 3 works with a budgeting/application processing 30 representative to complete a budget to assist the applicant in planning for and managing the financial commitments of the system auto financing. In the budgeting/application processing meeting 30 the applicant 3 also completes forms and documents necessary to (i) initiate and execute automatic payroll deposits from applicant's employer 21 to a designated bank account currently established by applicant 3 or a new applicant 3 bank account set-up for the purposes of receiving the automatic payroll deposits of the employees 23 employment paychecks to said account; and (ii) to allow the system 1 to automatically deduct system 1 auto financing payments from said applicant bank account.

Upon receiving approval from the budgeting/application processing 30 representative that the (i) budgeting and planning exercises have been completed; (ii) that the automatic payroll deposit forms have been completed; (iii) that a applicant 3 has a designated bank account currently established or has set up a new applicant 3 bank account for the purposes of receiving the automatic payroll deposits of the employees 23 employment paychecks to said account; and (iv) applicant has completed forms or documents authorizing the system 1 to deduct system 1 auto financing payments from said applicant bank account, then applicant 30 is approved for a system 1 financing, contingent upon completion of a verification of a direct deposit 31 of employee's 23 employment paycheck to said account.

Upon verification of direct deposit 31, applicant 3 selects an automobile from the automobile 2 makes and models available 5. Upon completing the selection process a system representative completes the appropriate auto 2 purchase and completes necessary documentation to execute the automobile 2 financing.

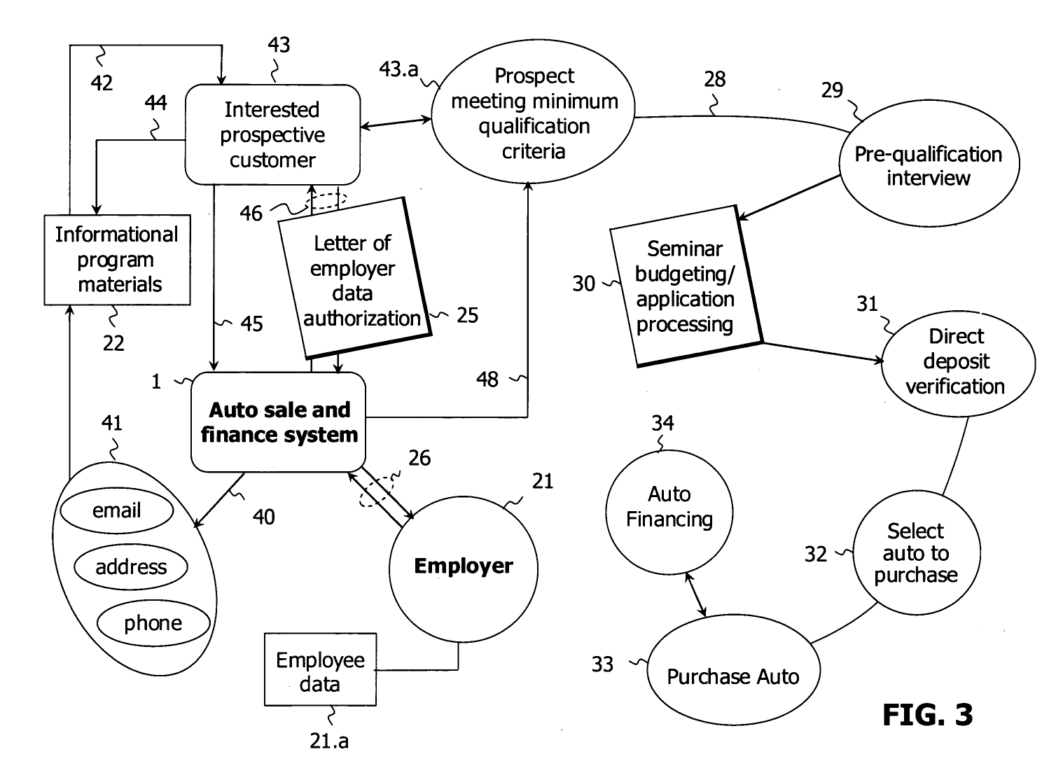

There is shown in FIG. 3 an alternative embodiment of the automobile sale and finance system 1 to sell and finance automobiles 2. In this embodiment the system 1 acquires or otherwise secures leads 40 of employees and related contact information 41 and distributes 42 system information program materials 22 to such leads 40. Employees 43 may also acquire 44 system information program materials 22 from point-of-purchase displays or system 1 established promotional program information distribution points 22. Upon receiving such system information program materials 22, interested prospective system 1 customers/employees 43 can contact the system 1 to find out more information about the program 45. At point of system 1 contact 45 with a prospective system 1 customer/employee 43, system delivers 46 a letter of authorization 25 from said prospective system 1 customers/employees 43 to confirm with their respective employer that prospective system 1 customers/employees 43 meets the minimum employment term requirement to participate or be approved for a system 1 financing. Upon receiving 46 the executed letter of authorization 25 from the prospective system 1 customers/employees 43, the system 1 provides the executed letter of authorization to the employer 26 requesting verification of the prospective system 1 customer/employee's 43 term of employment with the employer 21. Upon accessing the employee data files 21.a. the employer 21 verifies the employment term of the employee 26 to the system 1. Upon receipt of the employment term verification 26, the system 1 instructs employee 48 that they are authorized to contact a system representative 28 to set up a prequalification interview 29.

What is claimed is:

1. An automobile financing system, comprising:
utilizing employment term and/or employee performance data as credit worthiness criteria to determine whether to extend financing to an individual making application to purchase an automobile;
receiving employment data from applicant's employer to review for the purposes of reviewing to determine whether to extend automobile financing;

2. The system set forth in claim 1 where application provides a letter of authorization providing system with authority/right to request and receive applicant's employment data/records from applicant's employer;

3. The system set forth in claim 1 where applicant's employee records received by system include applicant's monthly salary or income level;

4. The system set forth in claim 1 where the applicant's driving record is also considered as credit worthiness criteria to determine whether to extend automobile financing;

5. The system set forth in claim 4 where applicant fills out an insurance application to provide system with rights to access driving record related information;

6. The system set forth in claim 5 where system works with insurance company insurance application is provided to, to access related driving record information;

7. The system set forth in claim 6 where system is an insurance company and accesses the related driving record information as an extension of its own internal insurance application processing procedures;

8. The system set forth in claim 2 where system provides letter of authorization to applicant's employer and requests verification of the term that applicant has been an employee of employer;

9. The system set forth in claim 8 where system requests the total number of applicant sick days during the term of employee's employment with employer or other employee performance data;

10. The system set forth in claim 8 where employer provides said employee data/records to system in response to the letter of authorization request;

11. The system set forth in claim 1 where global positioning system (“GPS”) are installed in automobiles financed under the system;

12. The system set forth in claim 1 where the system secures bumper-to-bumper warranties for automobiles financed under the system;

13. The system set forth in claim 1 where automobiles financed under the system are not more than 1 to 3 years old;

14. The system set forth in claim 1 where automobiles financed under the system do not have more than 50,000 miles on the automobiles odometer;

15. The system set forth in claim 1 where value of the quotient of the Kelly Blue book retail value minus the corresponding retail value divided by said retail value is equal to Twenty Five Percent (25%) or greater;

16. The system set forth in claim 1 where the automobile financing is provided to individuals with relatively low credit score or credit bureau rating (“sub-prime”), who under conventional credit score/rating systems are required to pay relatively high interest rate levels on auto loans;

17. The system set forth in claim 16 where the interest rate paid by applicants for automobiles financed under the system is at least Twenty Eight Percent (28%) less than applicant would otherwise pay through conventional sources for sub-prime automobile financing;

18. The system set forth in claim 10 where system approves applicant as meeting minimum employment term requirement;

19. The system set forth in claim 18 where based on conventional credit score/rating criteria applicant would otherwise only qualify for sub-prime auto financing as defined in claim 16;

20. The system set forth in claim 19 where applicant attends a system auto financing prequalification interview with a system representative;

21. The system set forth in claim 20 where the pre-qualification interview is conducted between applicant and system representative telephonically;

22. The system set forth in claim 20 where the pre-qualification interview is conducted between applicant and system representative using the Internet and any related electronic communication devices;

23. The system set forth in claim 20 where representative collects insurance application information defined in claim 5;

24. The system set forth in claim 20 where representative informs applicant that monthly auto payments for financing provided under the system are paid via an applicant bank account receiving direct deposits from applicant's employment pay checks;

25. The system set forth in claim 20 where applicant is informed they will receive the lower interest rate defined in claim 17;

26. The system set forth in claim 24 where applicant is informed that if a monthly auto payment is missed or late the system will repossess automobile more expeditiously than with conventional auto financing sources;

27. The system set forth in claim 25 where applicant agrees to the conditions defined in claims 24 and 26 to complete the system's application for financing;

28. The system set forth in claim 27 where system is a licensed auto insurance broker and secures applicant's driving record, so as to determine insurance rates that will be paid by applicant for full coverage of auto insurance during the term of the applicants system auto loan;

29. The system set forth in claim 28 and 23 where applicant's driving record is available and reviewed by system to estimate the cost for applicant to maintain full coverage auto insurance during the term of the system auto loan;

30. The system set forth in claim 29 where applicant is required to maintain full coverage auto insurance during the term of the system auto loan;

31. The system set forth in claim 30 where monthly payment (i) for applicant to maintain full coverage auto insurance on the system financed auto, and (ii) to pay the monthly cost of the system financed auto, is not disproportional or unmanageable given the applicant's monthly income as defined in claim 3;

32. The system set forth in claim 31 where the applicant meets preliminary system auto financing approval requirements;

33. The system set forth in claim 31 where applicant attends a budgeting/application processing meeting between applicant and system representative;

34. The system set forth in claim 33 where the budgeting/application processing meeting is conducted between applicant and system representative telephonically;

35. The system set forth in claim 33 where the budgeting/application processing meeting is conducted between applicant and system representative using the Internet and any related electronic communication devices;

36. The system set forth in claim 33 where applicant and representative complete a budget to assist the applicant in planning for and managing the financial commitments of the system auto financing;

37. The system set forth in claim 36 where representative approves applicant for a system auto financing;

38. The system set forth in claim 37 where applicant's employer can process automatic payroll deposits for employees;

38. The system set forth in claim 37 where applicant completes forms and submits automatic payroll deposit forms to applicant's employer;

39. The system set forth in claim 38 where system receives verification that an applicant payroll has been deposited to a system approved account, where system auto payments will be automatically deducted from as defined in claim 24;

40. The system set forth in claim 39 where applicant selects an automobile from a system generated list of auto choices for applicant to purchase;

41. The system set forth in claim 40 where the system generated list of auto choices meet the criteria defined in claim 13; 14: and 15;

42. The system set forth in claim 40 where system purchases the selected automobile;

43. The system set forth in claim 42 where the GPS unit defined in claim 11 is installed in the purchased automobile;

44. The system set forth in claim 43 where the system is an automobile dealership;

45. The system set forth in claim 43 where the automobile dealership secures financing for the applicant through a financial institution;

46. The system set forth in claim 45 where the automobile dealership guarantees performance of the applicant's corresponding automobile loan in exchange for financial institution providing a lower interest rate on the auto loan;

47. The system set forth in claim 45 where the lower interest rate on the auto loan is that defined in claim 17;
